(19) United States
(12) Patent Application Publication
(10) Pub. No.: US 2024/0288219 A1
(43) Pub. Date: Aug. 29, 2024

(54) DRYING DEVICE FOR DRYING CONTAINER UNITS AND METHOD

(71) Applicant: BELVAC PRODUCTION MACHINERY, INC., Lynchburg, VA (US)

(72) Inventors: Wilko HARMS, Wittmund (DE); Ulf REINHARDT, Teutschenthal (DE)

(21) Appl. No.: 18/570,790

(22) PCT Filed: Jun. 16, 2022
(86) PCT No.: PCT/EP2022/066527

§ 371 Date: Dec. 15, 2023

(30) Foreign Application Priority Data
Jun. 16, 2021 (DE) 10 2021 115 612.2

(51) Int. Cl. F26B 15/22; F26B 3/04; F26B 21/12; F26B 25/00

(52) U.S. Cl. CPC F26B 15/22; F26B 3/04; F26B 21/12; F26B 25/009

(57) ABSTRACT

The invention relates to a drying device for drying container units (1, 1′), in particular cans, comprising a conveying unit (102), in particular having transport pins, the conveying unit (102) being designed to convey the container units (1, 1′) along a drying section, a fluid flow device (108) which is designed to supply a fluid flow to the container units (1, 1′) at least in portions along the drying section, and a control device (122) which is coupled to the fluid flow device (108) for signal transmission and is configured to substantially steplessly adjust the fluid flow device (108) on the basis of a container property 10 of the container units (1, 1′) in order to supply the fluid flow having a predefined fluid flow property to the container unit.

### CROSS-REFERENCE TO RELATED APPLICATIONS

This application is a U.S. national stage of International Application No PCT/EP2022/066527, filed Jun. 16, 2022, which claims the benefit of and priority to German Patent Application No. 10 2021 115 612.2, filed Jun. 16, 2021, each of which are hereby incorporated by reference herein in its entirety.

### FIELD

The invention relates to a drying device and a method for drying container units, in particular cans, for example beverage cans.

### BACKGROUND

Drying devices, in particular pin ovens and continuous drying ovens, also known as Internal Bake Ovens (IBO), are basically known. Container units, such as cans for beverages, often have a coating on an outer shell surface that is formed as a coating of varnish or paint. Such a coating may, for example, display the brand name of the supplier, usage instructions or other content. In addition, the inner surfaces of the cans are typically coated in a process step downstream of the pin ovens and subsequently dried in the continuous drying oven. Further, such coatings are used that affect the manufacturing process of the can. For example, the cans are coated with such a varnish on an underside of the can to adjust the sliding ability of the cans on the different conveyor belts.

A device for applying such a coating to container units is also referred to as a printing apparatus. In order for this coating to remain durable, it must usually be cured after application. For this curing of the coating, for example, pin ovens are used in which the coating is convectively heated, dried, cured and/or baked.

Pin ovens usually have a conveying unit. The conveying unit may be a chain conveyor having transport pins which are arranged spaced from one another along its main extension direction. The container units are positioned by means of the transport pins. For this purpose, the transport pins protrude into the container units which are open at one end.

To enable the drying of the coating mentioned above, pin ovens usually have fans that provide airflow to the different portions within the pin oven. In particular, high fluid flow rates are required in an oven unit in which the container units are heated to approximately 180 degrees.

Large exhaust fans and recirculation fans are required for pin ovens to meet a wide variety of requirements. On the one hand, drying must be carried out safely. In addition, it must be ensured that the solvent input does not exceed a limit value in order to minimize the risk of explosion. In addition, regardless of the legal regulation, it must be ensured that no substantial deposits of the solvent, paint, paint components or dust occur in order to guarantee the functionality of the pin oven.

One disadvantage of existing pin ovens is that their energy consumption is high. In particular, the fans used, particularly for an oven chamber, are characterized by high power consumption. In addition, a heating unit, such as a gas burner or electric heater, is used to heat the fluid in the oven chamber, which also requires energy. In order to meet the increasing ecological requirements and rising sustainability criteria, the energy consumption of pin ovens must be reduced.

Another disadvantage of known pin ovens is that the electronic transmission of relevant information concerning can density and coating type is considered to be unreliable. Therefore, a minimum exhaust air volume or a minimum exhaust air flow in combination with a maximum solvent input must be defined for the pin oven.

It is therefore an object of the invention to provide a drying device, in particular a pin oven, and a method for drying container units which reduce or eliminate one or more of the disadvantages mentioned. In particular, it is an object of the invention to provide a solution that reduces the energy consumption of drying devices.

This object is achieved with a drying device and a method according to the features of the independent patent claims. Further advantageous embodiments of these aspects are given in the respective dependent patent claims. The features listed individually in the patent claims and the description can be combined with one another in any technologically useful manner, with further embodiments of the invention being shown.

### SUMMARY

According to one embodiment, a drying device, in particular a pin oven, for drying container units, in particular cans, is disclosed. The drying device includes a conveying unit, in particular having transport pins, wherein the conveying unit is designed for conveying the container units along a drying section. The drying device further incudes a fluid flow device which is designed to supply a fluid flow to the container units at least in portions along the drying section. The drying device further includes a control device which is coupled to the fluid flow device by means of signals and which is configured to substantially steplessly adjust the fluid flow device on the basis of a container property of the container units in order to supply the fluid flow having a predefined fluid flow property to the container units.

According to another embodiment, a method for drying container units, in particular cans, is disclosed. The method includes conveying the container units, in particular having transport pins, along a drying section. The method further includes supplying a fluid flow to the container units at least in portions along the drying section. The method further includes substantially steplessly adjusting of the fluid flow on the basis of a container property of the container units.

### BRIEF DESCRIPTION OF THE DRAWINGS

Preferred exemplary embodiments are explained by way of example with reference to the accompanying figures. In the figures:

FIG. 1: shows a schematic, two-dimensional side view of an exemplary embodiment of a pin oven;

FIG. 2: shows a schematic, two-dimensional detailed view of the pin oven shown in FIG. 1; and

FIG. 3: shows a schematic representation of an exemplary method.

In the figures, identical or substantially functionally identical or similar elements are designated by the same reference signs.

### DETAILED DESCRIPTION

In accordance with a first aspect, the object is achieved by a drying device, in particular a pin oven, for drying container units, in particular cans, comprising a conveying unit, in particular having transport pins, the conveying unit being designed to convey the container units along a drying section, a fluid flow device which is designed to supply a fluid flow to the container units at least in portions along the drying section, and a control device which is coupled to the fluid flow device by means of signals and is configured to substantially steplessly adjust the fluid low device on the basis of a container property of the container units in order to supply the fluid flow having a predefined fluid flow property to the container unit.

The invention is based on the realization that the known settings of fluid flow devices with, for example, three to five stages, do not allow energy-efficient use of drying devices, since with these it is not possible to set a fluid flow that meets the requirements. In addition, the inventors have found that coupling the setting of the fluid flow devices with container properties allows efficient control of the drying device. In particular, depending on kinetic, material-specific and/or geometric container properties, advantageous control can be made possible, which leads to a better resource efficiency. For example, such a drying device is characterized by a lower production of carbon dioxide.

The fluid flow device can be controlled by the control on the basis of the container property, in particular in such a way that an exhaust air flow and/or a recirculation air flow of the drying device is set such that, on the one hand, the legal and container-specific requirements are met and, on the other hand, a minimum energy consumption of the fluid flow device is ensured. On the basis of such a control, for example, the solvent input into the drying device can be used as a control parameter, rather than primarily the minimum exhaust air volume that is often used. Thus, the invention enables an energy-efficient drying device such that container units produced with such a drying device, for example beverage cans, also have an optimized environmental footprint.

The drying device can be, for example, a pin oven or a continuous drying oven (IBO). The invention is described below with reference to a pin oven. The described features, characteristics and advantages apply analogously to the drying device in general and to the continuous drying oven in particular.

The container units are intended in particular for stocking foodstuffs, especially liquid foodstuffs. For example, they may be cans, in particular beverage cans. The container units may be made of steel or aluminum, for example, or may comprise these materials. Further, composite materials for the container units are also conceivable. The container units usually have a cylindrical shell surface that can be closed at its ends. For example, the container units may be a deep-drawn component that is open at one end after the deep-drawing process and may be closed there with an openable closure.

The pin oven comprises in particular the conveying unit having transport pins. The conveying unit may be a chain, for example. In particular, the conveying unit is coupled to a drive unit such that it can be moved along the drying section. The transport pins are preferably arranged spaced from one another on the conveying unit. The transport pins are arranged and designed on the conveying unit in particular in order to position container units, in particular cans, thereon such that the container units can be moved along the drying section in a substantially stable position.

The pin oven further comprises the fluid flow device which is designed to supply a fluid flow to the container units at least in portions along the drying section. As explained in more detail below, the fluid flow device may have two or more fluid flow units, each of which provides a fluid flow at least in portions along the drying section.

The fluid flow device is designed in particular to guide a supply air flow from the environment of the pin oven into the pin oven, in particular into an oven chamber, and to guide an exhaust air flow out of the pin oven, in particular out of the oven chamber. In addition, the fluid flow device can create a recirculating air flow within the pin oven, particularly within the oven chamber. The fluid flow device can be designed as a fan, for example. In particular, it is preferred for the fluid flow device to have two or more or a plurality of fans.

The pin oven further comprises the control device, which is coupled to the fluid flow device by means of signals. The control device is configured to substantially steplessly adjust the fluid flow device on the basis of a container property of the container units.

Adjusting the fluid flow device relates in particular to adjusting a predefined fluid flow property. For example, the fluid flow property may be a fluid pressure, which may be specified in bar, for example, and/or a fluid volume flow, which may be specified in cubic meters per hour, for example.

Different fluid flow properties may be relevant in different portions of the pin oven. For example, within the pre-drying frame, one objective is to effect a specific fluid pressure on the outer base of the container units to ensure secure positioning of the container units on the transport pins. Inside the oven chamber, on the other hand, one object is to set a specific fluid volume flow.

As will be discussed in further detail below, the container property may be a conveying speed, a container unit density, a length, a diameter, a wall thickness, a paint composition, a paint and/or solvent amount of the container unit.

The fluid flow device is adjusted substantially steplessly by means of the control device on the basis of the container property. Substantially steplessly means in particular substantially continuously. Substantially steplessly may further mean that the fluid flow device is not discretely adjusted.

Substantially steplessly can further mean that a set fluid flow, for example measured in volume per unit time, deviates less than 10%, less than 5%, or less than 2.5% from a predefined fluid flow, for example specified in volume per unit time. Further, substantially steplessly may mean that the fluid flow device is adjustable with more than 10 steps, more than 20 steps, or more than 100 steps. Further, substantially steplessly may mean that a step interval between two successive steps is less than 10% of an adjustment range of the fluid flow device, less than 5% of the adjustment range, or less than 2.5% of the adjustment range.

The fluid flow device is adjusted such that the fluid flow has a predefined fluid flow property. The fluid flow property can be, for example, a fluid pressure and/or a provided volume of fluid per unit time. By means of a fluid flow device to be adjusted in this manner, the energy consumption for the fluid flow device is reduced, since the distance between an energy-optimal setting and an adjustable setting is small. In addition, energy consumption, for example gas consumption or electricity consumption, can be reduced for the heating oven, as optimized drying is made possible by means of the fluid flow. This further reduces the amount of exhaust gas aftertreatment, which in turn reduces the amount of energy required.

It is preferred that the pin oven comprises a heating unit, preferably the aforementioned gas burner, arranged and designed to heat the fluid flow in the oven chamber such that the container units are heated to a predetermined temperature for a predetermined time. For example, the predetermined temperature may be more than 180 degrees Celsius. For example, the predetermined time may be at least 0.5 seconds, preferably at least 1 second.

It is preferred that the container property be a kinematic container property. In particular, it is preferred that the container property characterizes a conveying speed at which the conveying unit conveys the container units. Furthermore, it is preferred that the container property is a container unit density, which characterizes a transported number of container units per unit time. The container unit density describes in particular the number of container units entering the pin oven and/or conveyed through the pin oven per unit of time. For example, the container unit density may be 2,500 container units per minute.

A preferred embodiment of the pin oven comprises a density measuring unit configured to detect the container unit density. It is preferred that the density measuring unit is configured to generate and/or provide a density signal characterizing the container unit density. It is further preferred that the density measuring unit has two or more density measuring sensors for redundant detecting of the container unit density.

The density measuring unit can be a counting unit, for example. The density measuring unit preferably comprises one, two or more optical sensors, for example light barriers, inductance sensors, color sensors and/or infrared sensors. Further, the density measuring unit may have inductance sensors, capacitance sensors, magnetic sensors, and/or proximity sensors, such as ultrasonic sensors. In particular, the density measuring sensors can be designed as such. Alternatively or additionally, the density measuring unit may have a camera or a line control.

A further preferred embodiment of the pin oven is characterized in that it comprises a fluid flow measuring unit for detecting the exhaust air flow exiting the pin oven, in particular the oven chamber, wherein preferably the fluid flow measuring unit has two or more fluid flow measuring sensors for redundantly detecting the exhaust air flow exiting the pin oven, in particular the oven chamber.

It is preferred that the fluid flow device is or comprises a fluid flow unit of an oven chamber. Such a fluid flow unit is designed in particular for forming the supply air flow and the exhaust air flow into and out of the oven chamber, respectively.

It is particularly preferred that the pin oven has the density measuring unit and the fluid flow measuring unit, wherein each is designed to measure redundantly. Such a pin oven advantageously enables for a variable can density and a variable exhaust air volume to be measured. This means that the safety regulations of some regions can be met without having to guarantee a fixed minimum exhaust air volume. This also provides a reliable method of measuring the solvent concentration in the oven chamber, as required, for example, by the EN1539 standard. Consequently, it is not necessary to specify a minimum exhaust air volume and a maximum solvent input for the pin oven. It is therefore sufficient to specify a maximum solvent input per can and a maximum container unit density of the pin oven in order to set a minimum exhaust air flow. The solvent input is determined from the maximum can surface area, in particular the shell surface, and an indication of the amount of paint required to coat the can surface.

Furthermore, it is preferred that the pin oven comprises a speed measuring unit configured to detect the conveying speed. The speed measuring unit is preferably configured to generate and/or provide a speed signal characterizing the conveying speed. The speed measuring unit may have, for example, a light barrier and/or an induction sensor. It is particularly preferred that the speed measuring unit has a light barrier and an induction sensor to enable redundant detection of the conveying speed.

Another preferred embodiment of the pin oven is characterized in that the control device is configured to adjust the fluid flow device based on the density signal and/or the speed signal. For example, the greater the container unit density, the greater the solvent input into the pin oven. In addition, a greater fluid flow is typically required when the container units are conveyed through the pin oven at a high speed to ensure drying of the coating on the container units.

Another preferred embodiment of the pin oven is characterized by the fact that the control device is configured to steplessly adjust the fluid flow device such that a predefined fluid pressure and/or a conveyed fluid volume per unit time can be provided.

In another preferred embodiment of the pin oven, it is provided that the control device is configured to adjust the fluid flow device on the basis of at least one container condition of the container units. The container condition describes, for example, a length, a diameter, a wall thickness, a paint and/or solvent quantity, a paint type, a paint composition, and/or a paint density.

The fluid flow to be set depends, inter alia, on how the container units are designed. For example, container units with a large wall thickness have a different heating curve than container units with a small wall thickness. In addition, the length of the container units may also be a container property to consider, since the effect of fluid flow on the different areas of a long container unit is different than on a short container unit.

Taking into account the container condition when adjusting the fluid flow device allows for more precise adjustment such that the adjusted fluid flow property is set as close as possible to an optimal fluid flow property. Thus, the required energy input can be further reduced.

A preferred embodiment of the pin oven is characterized by comprising a condition measuring device arranged and configured to detect the at least one container condition, wherein preferably the at least one container condition is a shell surface of the container units, wherein the control device is configured to determine a solvent input based on the detected container condition and the detected container unit density.

It is preferred that the condition measuring device is arranged and designed to generate and/or provide a condition signal characterizing the container condition. The control device is configured, in particular, to receive and process the condition signal and to determine the solvent input based on the condition signal.

Since the shell surface has an influence on the paint quantity or the solvent input per can, a solvent quantity specified according to can size can be determined on the basis of the shell surface in order to be able to determine the required minimum exhaust air flow even more precisely.

For example, the condition measuring device may be arranged and designed to detect a color of the container units. Based on a color for container units, their solvent quantity can be inferred. With information characterizing the color of a container unit, the control device can, for example, determine the solvent input per container unit. Taking into account the container unit density, the control device can further determine the solvent input. The solvent input is to be understood in particular in relation to a time unit. The condition measuring device is in particular arranged in a pre-drying frame of the pin oven.

The minimum exhaust air volume or minimum exhaust air flow mentioned at the outset is usually determined on the basis of a maximum container size, for example 500 ml, a maximum paint volume per container unit and a maximum container unit density, for example 2,500 container units per minute. In principle, the exhaust air flow must not fall below this minimum. The minimum exhaust air flow reduces the possibility to adjust the fluid flow device in an energy-optimal manner.

The invention is further based on the realization that the minimum exhaust air flow can be made variable if the container size, the amount of paint per container and/or the container unit density can be reliably determined. For example, if the container size is reliably determined, the minimum exhaust air flow can be reduced, since the actual size and, for example, not the previously mentioned container maximum size is to be used.

Another preferred embodiment of the pin oven is characterized in that the control device is configured to determine a minimum exhaust air flow taking into account a determined solvent input. It is preferred that the control device is configured to determine the solvent input based on a container unit size, a solvent amount per container unit, and/or the container unit density. If no reliable measured value is available for one of these parameters, a maximum value is used for it.

It is further preferred that the control device controls the fluid flow device such that the fluid flow device conveys the minimum exhaust air flow from the pin oven, in particular the oven chamber. Further, the control device may be configured to take into account a safety factor when determining the exhaust air flow such that the exhaust air flow to be set is greater than the minimum exhaust air flow.

The container unit size can be determined, for example, on the basis of the shell surface. The solvent input can be determined, for example, as a function of the container unit density, the shell surface and the solvent quantity, in particular the weight per volume, and specified in weight per time. Based on such a determination, the actual amount of solvent introduced per time unit is taken into account, so that no measurement of the amount of solvent in the air is required.

In another preferred embodiment, the control device is configured to adjust the fluid flow device on the basis of a power output of the heating unit. The lower the solvent input, the lower the exhaust air flow. This results in less supply air and recirculated air, so there is little energy loss. As a result, less power is required from the heating unit, in particular less burner power, so that the exhaust air flow can be reduced.

A further preferred embodiment of the pin oven is characterized in that it comprises a fluid inlet unit for admitting a supply air flow into the pin oven, with the control device being coupled to the fluid flow inlet unit by means of signals and being configured to control the fluid inlet unit such that the supply air flow entering the pin oven substantially corresponds to the exhaust air flow exiting the pin oven.

Such control of the fluid inlet unit prevents substantial amounts of fluid flow from entering or exiting through a container unit inlet and container unit outlet. This allows the fluid flow within the pin oven to be controlled in a targeted manner.

In particular, the fluid inlet unit can be controlled and/or regulated by the control device. That the supply air flow entering the pin oven is substantially the same as the exhaust air flow exiting the pin oven means, in particular, that the entering fluid flow and the exiting fluid flow do not differ by more than 10%, not more than 20%, or not more than 30%.

Another preferred embodiment of the pin oven is characterized in that it comprises an oven chamber for supplying a heated fluid to the container units, wherein the fluid flow device comprises a recirculating fluid unit arranged and designed to circulate fluid within the oven chamber. The oven chamber can be the aforementioned oven chamber.

It is further preferred that a differential pressure of the recirculating air unit, in particular in a flow direction of the fluid upstream and downstream of the recirculating fluid unit, is determined. For example, the differential pressure can be based on a measured pressure in the direction of flow of the fluid upstream of the recirculating fluid unit and a measured pressure in a direction of flow of the fluid downstream of the recirculating fluid unit.

The control device is further preferably configured to detect a material deposit when the differential pressure changes at a reference speed of the recirculating fluid unit and a reference temperature. The reference speed and the reference temperature can be selected substantially arbitrarily. It is crucial that the differential pressure remains substantially constant at the same speed and the same temperature without material deposits, so that a material deposit can be inferred when the differential pressure changes.

The exhaust air flow is in particular the fluid flow exiting the oven chamber, for example caused by the aforementioned fluid flow unit of the oven chamber. The control device is preferably configured to output a warning signal when a fault is detected. In particular, the oven chamber is designed to heat the fluid such that the container units are heated to a temperature of at least 180 degrees Celsius for at least a predetermined period of time, in particular a short period of time, for example 0.5 seconds or 1 second.

A further preferred embodiment of the pin oven is characterized in that it comprises at least two temperature sensors which are coupled to the control device by means of signals and are configured to detect a container temperature of the container units along the drying section within the oven chamber, with the control device being configured to determine a temperature profile of the container units along the drying section. Preferably, the pin oven comprises a plurality of temperature sensors. Based on the temperature profile, it can be determined in an advantageous manner whether the container units are exposed to the required maximum temperature for a sufficiently long time. The temperature sensors can be infrared sensors, for example.

A further preferred embodiment of the pin oven is characterized in that the fluid flow device comprises or is a stabilizing unit designed for stabilizing the container units, wherein the stabilizing unit can be adjusted by the control device such that the container units are stabilized on the transport pins on the basis of the container property. The stabilizing unit can act in portions or completely along the drying section.

In particular, the stabilizing unit is arranged and designed to direct the fluid flow onto the bases of the container units such that they are pressed onto the transport pins. The adjustment of the stabilizing unit on the basis of the container property is advantageous, for example, in that at low conveying speeds a lower pressure is required than at high conveying speeds. Consequently, energy costs of the stabilizing unit can be reduced.

A further preferred embodiment of the pin oven is characterized in that the fluid flow device comprises or is a cooling unit designed for cooling the container units, wherein the cooling unit can be adjusted by the control device such that the container units are cooled on the basis of the container property.

For example, a container unit with a long length or a thick wall thickness requires more cooling than a short container unit with a thin wall thickness. In particular, the cooling unit is designed to cool the container units by delivering the fluid flow.

In particular, the cooling unit is arranged and designed to supply a fluid flow to the container units so that the container units are cooled. The control device is preferably configured to control the cooling unit on the basis of the container unit density and/or the conveying speed. For example, a dwell time of the container units in the cooling unit is longer when the conveying speed is lower, so that they are exposed to fluid flow for a longer period of time. As a result, the fluid flow can be throttled to effect the same temperature of the container units at the outlet of the cooling unit.

It is preferred that one of or a temperature measuring sensor is arranged at the outlet of the cooling unit for measuring a temperature of the container units, and the control device is configured to control the fluid flow device based on the temperature of the container units.

In another preferred embodiment, the pin oven is provided with a condensate separator. In particular, it is preferred that the condensate separator is arranged within a recirculation system of the pin oven. Alternatively or additionally, the condensate separator can be arranged in a pipeline downstream of the exhaust air purification system. Furthermore, it is preferred that the condensate separator is coupled to the control device by means of signals, and that the control device is configured to control the condensate separator on the basis of the container property of the container units.

A further preferred embodiment of the pin oven is characterized in that the fluid flow device comprises or is a container removal unit designed for removing the container units from the transport pins, wherein the container removal unit can be adjusted by the control device based on the container property. The container removal unit generates a negative pressure in particular to remove the container units from the transport pins.

In particular, this negative pressure is exerted on the bases of the container units. The container removal unit removes the container units in particular shortly before a radius, so that the radius of the container removal unit, the mass of the container units and the conveying speed in the area of the container removal unit are relevant container properties.

It is preferred that the individual units or components of the fluid flow device are arranged in a defined sequence along the drying section. It is preferred that the stabilizing unit is arranged at the beginning of the drying section, adjacent to a printing apparatus. A container unit bottom coater is preferably arranged downstream of the stabilizing unit. The oven chamber with the fluid flow unit and the recirculating fluid unit is preferably arranged further downstream. Further downstream, it is preferred that the cooling unit is arranged to cool the container units heated in the oven chamber. The container removal unit is preferably arranged further downstream from the cooling unit.

In accordance with a further aspect, the object mentioned at the outset is achieved by a method for drying container units, in particular cans, comprising the steps of: conveying the container units with transport pins along a drying section, supplying a fluid flow to the container units at least in portions along the drying section, substantially steplessly adjusting the fluid flow on the basis of a container property of the container units.

It is further preferred that the method comprises one, two or more of the following steps: detecting a container unit density, detecting a conveying speed, adjusting the fluid flow device based on the container unit density and/or the conveying speed, adjusting a predefined fluid pressure and/or a conveyed fluid volume per time unit, adjusting the fluid flow on the basis of at least one container condition of the container units, detecting at least one container condition, determining a solvent input based on the detected container condition and the container unit density, adjusting the fluid flow based on the solvent input such that a predefined solvent input is substantially not exceeded, controlling an entering fluid flow such that it substantially corresponds to an exiting fluid flow, detecting an exiting fluid flow, circulating fluid within an oven chamber, detecting a material deposit on the basis of the container property, in particular the conveying speed, the container condition, and an exhaust fluid volume, detecting a container temperature of the container units along the drying section within the oven chamber, determining a temperature profile of the container units along the drying section, stabilizing the container units on the transport pins on the basis of the container property, cooling the container units with the fluid flow on the basis of the container property, removing the container units from the transport pins, wherein the fluid flow required for this is set based on the container property.

The method and its possible further developments have features or method steps that make them particularly suitable for being used for a pin oven and its further developments.

For further advantages, embodiment variants and embodiment details of the method and its possible further developments, reference is also made to the description given previously regarding the corresponding features and further developments of the pin oven.

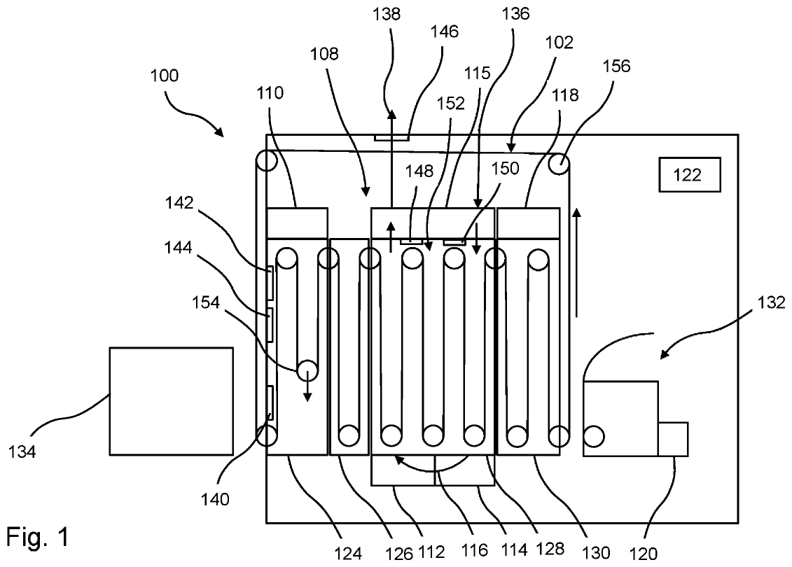

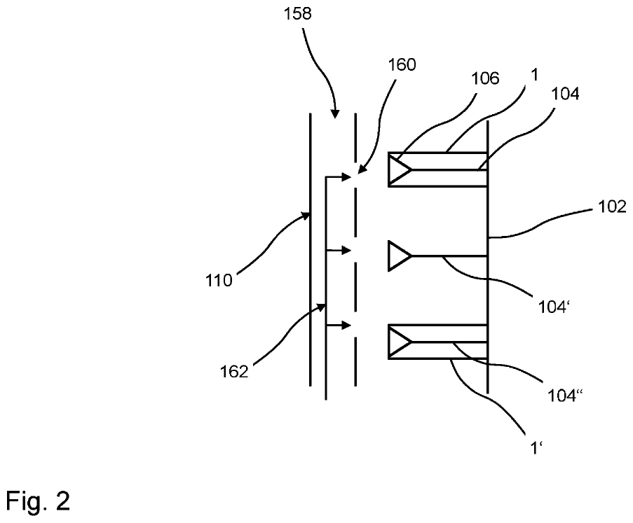

FIG. 1 shows a pin oven 100. The pin oven 100 comprises a conveying unit 102, which is designed as a chain. The conveying unit 102 comprises the transport pins 104, 104′, 104″ shown in FIG. 2. Container units 1, 1′ can be arranged on the transport pins 104, 104′, 104″ and thus conveyed along the meandering drying section. The pin oven 100 further comprises a fluid device 108. The fluid device 108 comprises a stabilizing unit 110, a recirculating fluid unit 112, a fluid flow unit 115, a cooling fluid unit 118, and a container removal unit 120.

The container units 1, 1′ are coated in a printing device 134 not comprised by the pin oven 100, in particular with a paint which contains solvent. From the printing device 134, the container units 1, 1′ are transferred to the pin oven 100. The printing device 134 and the pin oven 100 may be coupled such that the printing device 134 drives the conveying unit 102.

The container units 1, 1′ first enter a pre-drying frame 124. A stabilizing unit 110 acts in the pre-drying frame 124 to stabilize the container units 1, 1′ with a fluid flow at the conveying unit 102. The stabilizing unit 110 is coupled to and adjusted by a control device 122 such that the container units 1, 1′ are stabilized on the transport pins 104, 104′, 104″ on the basis of container properties. In addition, a chain tensioner 154 is provided within the pre-drying frame 124 to tension the chain of the conveying unit 102 such that it always has a predefined tension.

The pin oven 100 further has a density measuring unit 140 which measures the container units 1, 1′ entering the pin oven per time unit. The density measuring unit 140 may have two or more density measuring sensors to enable redundant measurement of the container unit density. In addition, the pin oven 100 has a speed measuring unit 142 which measures the conveying speed at which the container units 1, 1′ are conveyed through the pin oven. Further, the pin oven 100 has a container measuring unit 144 configured to measure container properties, for example, a length, a wall thickness, a container condition.

Downstream of the pre-drying frame 124, the pin oven 100 has a bottom coater 126. Downstream of the bottom coater 126, the pin oven 100 has an oven unit 128. The oven unit 128 forms an oven chamber 152 in which the container units 1, 1′ are heated to a high temperature, such as greater than 180 degrees Celsius for at least 0.5 seconds. For this purpose, the oven unit 128 has a heating unit 114. The heating unit 114 may be a gas burner, for example. The heating unit 114 is coupled to a recirculating fluid unit 112 which moves the fluid flow in the fluid flow direction 116, that is, first from the oven chamber 152 into the heating unit 114, subsequently into the recirculating fluid unit 112, and subsequently back into the oven chamber 152. Thus, a heated fluid flow is provided to the oven chamber 152.

The oven unit 128 is further coupled to a fluid flow unit 115. The fluid flow unit 115 is arranged and designed to provide the oven unit 128 with a fluid from the environment of the pin oven 100, and to guide a fluid out of the oven unit 128. For this purpose, the pin oven has a fluid inlet device 136 and a fluid outlet device 138. The fluid outlet device 138 is further coupled to a fluid flow sensor 146 which is configured to measure fluid flow.

Furthermore, a first temperature sensor 148 and a second temperature sensor 150 are arranged in the oven chamber 152, which are configured to detect a container temperature of the container units 1, 1′ along the drying section. The control device 122 is preferably configured to determine a temperature profile of the container units 1, 1′ along the drying section. Furthermore, it may be preferable to arrange three or more, in particular a plurality, of temperature sensors, for example, to determine a detailed temperature profile.

Downstream of the oven unit 128, a cooling zone 130 is provided. Cooling zone 130 is optional for pin oven 100 and usually not mandatory. In the cooling zone 130, a cooling fluid unit 118 is arranged and designed to cool the container units 1, 1′ with a fluid flow. A container extractor 132 is located at the outlet of the cooling fluid unit 118. The container extractor 132 has a container removal unit 120, which uses a fluid flow to exert a negative pressure on the bases of the container units 1, 1′ and thus removes them from the conveying unit 102 and can move them to a downstream process step.

This portion of the conveying unit 102 moves from there back to the entrance of the pin oven 100. The conveying unit 102 is guided by a plurality of rollers 156.

FIG. 2 shows a detail of the pin oven 100, namely the stabilizing unit 110. The stabilizing unit 110 comprises an air duct 158. Openings 160 are provided on one side of the air duct 158. A fluid flow 162 guided in the air duct 158 exits through the opening 160 and from there exerts a fluid pressure on the container units 1, 1′. Due to this pressure, the container units 1, 1′ are pressed onto the transport pins 104, 104′, 104″ or onto the holding element 106 of the transport pins 104, 104′, 104″, respectively. As a result, the container units 1, 1′ are stabilized.

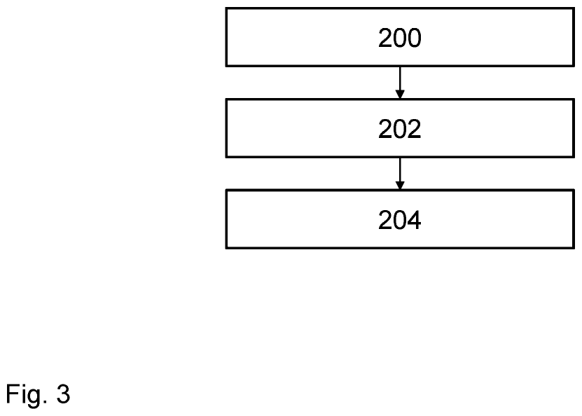

FIG. 3 shows a schematic representation of a method for drying container units 1, 1′, in particular cans. In step 200, the container units 1, 1′ are conveyed along a drying section with transport pins 104, 104′, 104″. In step 202, which can run partially or completely parallel to step 200, the container units 1, 1′ are supplied with a fluid flow at least in portions along the drying section. Meanwhile, in step 204, the fluid flow is adjusted substantially steplessly on the basis of a container property of the container units 1, 1′.

By steplessly adjusting the fluid flow device 108 on the basis of the container properties of the container units 1, 1′, an efficient drying process can be provided for the container units 1, 1′ using the pin oven 100. Compared to known pin ovens, such a pin oven 100 conserves resources and requires less energy.

Further energy savings can be achieved by components of the pin oven 100, such as detection of velocities and container properties or container conditions, so that the fluid flow device 108 can be controlled such that the required engineering effects, such as drying and reduction of the solvent input, can be achieved while still consuming as little energy as possible.

### REFERENCE SIGNS

1, 1′ container unit
100 pin oven
102 conveying unit
104, 104′, 104″ transport pin
106 holding element
108 fluid flow device
110 stabilizing unit
112 recirculating fluid unit
114 heating unit
115 fluid flow unit
116 fluid flow direction
118 cooling fluid unit
120 container removal unit
122 control device
124 pre-drying frame
126 bottom coater
128 oven unit
130 cooling zone
132 container extractor
134 printing device
136 fluid inlet device
138 fluid outlet device
140 density measuring unit
142 speed measuring unit
144 container measuring unit
146 fluid flow sensor
148 first temperature sensor
150 second temperature sensor
152 oven chamber
154 chain tensioner
156 roller
158 air duct
160 openings
162 fluid flow

1. A drying device, in particular a pin oven, for drying container units, in particular cans, comprising:
a conveying unit, in particular having transport pins, wherein the conveying unit is designed for conveying the container units along a drying section;
a fluid flow device which is designed to supply a fluid flow to the container units at least in portions along the drying section; and
a control device which is coupled to the fluid flow device by means of signals and which is configured to substantially steplessly adjust the fluid flow device on the basis of a container property of the container units in order to supply the fluid flow having a predefined fluid flow property to the container units.

2. The drying device according to claim 1, wherein the container characteristic is a conveying speed at which the conveying unit conveys the container units and/or a container unit density characterizing a conveyed number of container units per unit time.

3. The drying device according to claim 1, further comprising a density measuring unit configured for detecting the container unit density, wherein preferably the density measuring unit has two or more density measuring sensors for redundantly detecting the container unit density.

4. The drying device according to claim 1, further comprising a fluid flow measuring unit for detecting the exhaust air flow exiting the pin oven, wherein preferably the fluid flow measuring unit has two or more fluid flow measuring sensors for redundantly detecting the exhaust air flow exiting the pin oven.

5. The drying device according to claim 1, further comprising a speed measuring unit configured for detecting the conveying speed, wherein preferably the speed measuring unit has a light barrier and/or an induction sensor.

6. The drying device according to claim 1, wherein the control device is configured to steplessly adjust the fluid flow device such that a predefined fluid pressure and/or a conveyed fluid volume per unit time can be provided.

7. The drying device according to claim 1, wherein the control device is configured to adjust the fluid flow device on the basis of at least one container condition of the container units.

8. The drying device according to claim 1, comprising a condition measuring device arranged and designed to
detect the at least one container condition, wherein preferably the at least one container condition is a shell surface of the container units,
wherein the control device is configured to determine a solvent input based on the detected container condition and the detected container unit density.

9. The drying device according to claim 1, wherein the control device is configured to determine a minimum exhaust air flow taking into account the solvent input, and preferably that the control device controls the fluid flow device such that the fluid flow device conveys the minimum exhaust air flow out of the pin oven, in particular the oven chamber.

10. The drying device according to claim 1, wherein the control device is configured to determine the solvent input based on a container unit size, a solvent amount per container unit, and the container unit density.

11. The drying device according to claim 1, further comprising a fluid inlet unit for admitting a supply air flow into the pin oven, wherein the control device is coupled to the fluid inlet unit by means of signals and is configured to control the fluid inlet unit-such that the supply air flow entering the pin oven substantially corresponds to the exhaust air flow exiting the pin oven.

12. The drying device according to claim 1, further comprising an oven chamber for supplying a heated fluid to the container units, wherein
the fluid flow device comprises a recirculating fluid unit arranged and designed to recirculate fluid within the oven chamber, and
the control device is configured to detect a material deposit when a differential pressure of the recirculating fluid unit changes at a reference speed of the recirculating fluid unit and a reference temperature.

13. The drying device according to claim 1, further comprising
at least two temperature sensors coupled to the control device by means of signals, which are configured to detect a container temperature of the container units along the drying section within the oven chamber,
wherein the control device is configured to determine a temperature profile of the container units along the drying section.

14. The drying device according to claim 1, wherein the fluid flow device
comprises or is a stabilizing unit designed for stabilizing the container units, and
wherein the stabilizing unit is adjustable by the control device such that the container units are stabilized on the transport pins on the basis of the container property.

15. The drying device according to claim 1, wherein the fluid flow device
comprises or is a cooling unit designed for cooling the container units,
wherein the cooling unit is adjustable by the control device such that the container units are cooled on the basis of the container property.

16. The drying device according to claim 1, wherein the fluid flow device
comprises or is a container removal unit designed for removing the container units from the transport pins,
wherein the container removal unit is adjustable by the control device on the basis of the container property.

17. A method for drying container units, in particular cans, comprising the steps of:
conveying the container units, in particular having transport pins, along a drying section;
supplying a fluid flow to the container units at least in portions along the drying section; and
substantially steplessly adjusting of the fluid flow on the basis of a container property of the container units.
